(19) United States
(12) Patent Application Publication
(10) Pub. No.: US 2014/0166485 A1
(43) Pub. Date: Jun. 19, 2014

(54) ELECTROADSORPTION AND CHARGE BASED BIOMOLECULE SEPARATION AND DETECTION IN POROUS SENSORS

(71) Applicants: Michael J. Sailor, La Jolla, CA (US); Michelle Y. Chen, Anaheim, CA (US)

(72) Inventors: Michael J. Sailor, La Jolla, CA (US); Michelle Y. Chen, Anaheim, CA (US)

(73) Assignee: THE REGENTS OF THE UNIVERSITY OF CALIFORNIA, Oakland, CA (US)

(21) Appl. No.: 14/114,688

(22) PCT Filed: May 2, 2012
(86) PCT No.: PCT/US12/36163

§ 371 Date: Jan. 27, 2014

Related U.S. Application Data
(60) Provisional application No. 61/481,622, filed on May 2, 2011.

(51) Int. Cl. G01N 27/447

(52) U.S. Cl. CPC G01N 27/447
USPC 204/548; 204/450

(57) ABSTRACT

Electroadsorption and charged based biomolecule separation, concentration and detection with porous biosensors. In preferred embodiments, a potential is applied to a porous electrode to separate and concentrate molecules from solution. The bimolecular analytes are captured by the porous electrode itself, the same electrode that is used to generate the electric field for electroadsorption. In additional preferred embodiments, pH of the solution is adjusted to separate and concentrate biomolecules. Setting the pH equal to the protein isoelectric point was determined by the inventors to maximize concentration of biomolecules into the porous biosensor. The methods include simultaneously optically detecting charged molecules captured by the porous electrode. Methods of the invention are benign to biomolecules of interest, which are demonstrated to retain a high percentage of their activity after being released from the biosensor. Methods of the invention provide label-free detection. Advantageously, small voltages and ultrasmall volumes of solution are used in methods of the invention.

### PRIORITY CLAIM AND REFERENCE TO RELATED APPLICATION

The application claims priority under 35 U.S.C. §119 from prior provisional application Ser. No. 61/481,622, which was filed on May 2, 2011.

### STATEMENT OF GOVERNMENT INTEREST

This invention was made with government support under Contract No. DMR-0806859 awarded by National Science Foundation. The government has certain rights in the invention.

### FIELD

Example fields of the invention include analyte detection and biosensing. Example applications of the invention include bioanalytical systems (e.g., replacement for electrophoresis), drug delivery systems, and point-of-care diagnostic tools.

### BACKGROUND

The fidelity of detection in a biosensor is limited by its ability to identify small quantities of analyte in the presence of substantial and often much larger quantities of interfering molecules. Separation, preconcentration, and detection of the analyte are key aspects of the analysis. The drive to decrease sample volumes and increase throughput has led to chip-based microanalysis systems that combine these components within a volume of a few cubic micrometers.

Electric fields, applied via external electrodes or photogenerated in a semiconducting matrix, are often employed to enhance biomolecular separation in such systems. For example, electroadsorption typically concentrates a charged analyte on a solid metal electrode surface or on liquid mercury, and electrophoresis induces migration and separation of charged species.

Early work demonstrated single-molecule transport in a nanopore constructed from a natural membrane protein. Following that work other nanoscale porous structures have been developed, such as α-haemolysin (Bayley, H. et al., “Stochastic Sensors Inspired by Biology” Nature 413, 226-230 (2001)), artificial polymeric (Howorka, S. et al. “Nanopore Analytics: Sensing of Single is Molecules” Chemical Society Reviews 38, 2360-2384 (2009)), inorganic (Howorka et al [supra]; Li, J. et al., “Ion-beam Sculpting at Nanometre Length Scales” Nature 412, 166-169 (2001); Striemer, C. C. et al., “Charge- and Size-Based Separation of Macromolecules Using Ultrathin Silicon Membranes” Nature 445, 749-753 (2007)), and composite (Wanunu, M. et al., “Chemically-Modified Solid State Nanopores” Nano. Lett. 7 (2007)).

Carbon nanotubes and other nanostructures have also been used for molecule transport. The constricted environment in a nanopore has a substantial influence on molecular transport that can be harnessed for biosensing. (Choi, Y., et al., “Biosensing with Conically Shaped Nanopores and Nanotubes” Phys. Chem. Chem. Phys. 8, 4976-4988 (2006); Siwy, Z. et al., “Protein Biosensors Based on Biofunctionalized Conical Gold Nanotubes” J. Am. Chem. Soc. 127, 5000-5001 (2005)) filtration (Streimer et al. [supra]; Han, J., et al., “Molecular Sieving Using Nanofilters: Past, Present and Future” Lab Chip 8, 23-33 (2008).

Diffusion or migration of biomolecules is often accomplished by applying an electric field. This technique has been used to enhance the rate and selectivity of ionic transport in various microfluidic devices (Li, Q. et al., “Practical Aspects of in Vivo Detection of Neuropeptides by Microdialysis Coupled Off-Line to Capillary LC with Multistage MS,” Anal. Chem. 81, 2242-2250 (2009)) and nanotube membranes (Yu, S. et al., “Electrophoretic Protein Transport in Gold Nanotube Membranes,” Anal. Chem. 75, 1239-1244 (2003)).

Such electrophoretic transport through membranes requires significant voltages to generate the necessary electric field strength. Typically greater than 1 KV applied voltage is needed to achieve field strength in the range of 100 V/cm to 500 V/cm. Because of the high voltages needed to produce electrophoretic transport the electrodes in these experiments are usually far removed from the separation matrix to avoid excessive heating or degradation of the analyte molecules. (Li, Q. et al [supra]). Charged molecules can be moved is with significantly smaller voltages (Gurtner, C., et al., “Photoelectrophoretic Transport and Hybridization of DNA Oligonucleotides on Unpatterned Silicon Substrates,” J. Am. Chem. Soc. 122, 8589-8594 (2000)).

Electroadsorption is a well-established means to concentrate analytes (including biologicals) on electrode surfaces that are then forwarded downstream to a separate detector (Wandlowski et al. [supra]; Ban, A., et al., “Fundamentals of Electrosorption on Activated Carbon for Wastewater Treatment of Industrial Effluents,” J. Appl. Electrochem. 28, 227-236 (1998); Koresh, J. et al., “Stereoselectivity in Ion Electroadsorption and in Double-Layer Charging of Molecular-Sieve Carbon Electrodes” J. Electroanal. Chem. 147, 223-234 (1983); Salitra, G., et al., “Carbon Electrodes for Double-Layer Capacitors—I. Relations Between Ion and Pore Dimensions,” J. Electrochem. Soc. 147, 2486-2493 (2000). Electroadsorption involves the adsorption of ionized species onto an electrode surface upon application of small potentials (typically <1V) (Wandlowski, T., et al., “Structure and Stability of Cytosine Adlayers on Au(111): An in-situ STM Study,”. J. Electroanal. Chem. 404, 215-226 (1996)). The distance traveled by the ions is relatively small (few nm), and the quantity of material that can be moved is also small, usually corresponding to less than a monolayer on the electrode surface. Nevertheless, in solutions containing low analyte concentrations, electroadsorption (or photoinduced electroadsorption) can yield dramatic increases in sensitivity of detection, especially when coupled to immunological, electrochemical, ellipsometric, or fluorescence assays. See, e.g., Eckermann, et al., “Electrochemistry of Redox-Active Self Assembled Monolayers,” Coord. Chem Rev. 254, 1769-1802 (2010); Bjorklund, R. B., et al., “Ellipsometric and Reflectance Study of Electroadsorption from a Water-Based Metalworking Fluid onto Gold Surfaces,” Langmuir 8, 571-576 (1992). The electrode surfaces of pre-concentrators are often non-porous and metallic, although electroadsorption has also been conducted on porous carbon (graphitic) electrodes. After pre-concentration of an analyte, the analyte is typically subsequently released in a bolus to some form of down-stream detector. The prior electroadsorption techniques are unsuitable for label-free optical interferometric biosensing due, in part, to the lack of transparent porous conductors that are stable in relevant aqueous media.

Membranes with abiotic micro- or nanometer sized pores have been used for sensing, filtration, controlled release and gating of biological molecules. They are typically considered to be more stable and predictable than biological pores. The properties of the membranes provide a range of synthetic alternatives to control analyte transport behavior, sensitivity, and specificity. Porous silicon (pSi) membranes offer a versatile platform for studies of protein transport and binding: the porous nanostructure can be controlled during synthesis to yield a range of pore sizes, and optical structures can be incorporated into the films to provide sensitive, label-free quantification of biomolecules.

Porous silicon films have been previously demonstrated to separate biomolecules based upon size and negative native charge of the surface of oxidized porous silicon. See, e.g., Kosmulski, “In Adsorption on Silica Surfaces,” Papirer, E., Ed.; Marcel Dekker: New York, 2000; Vol. 90, pp 363-364; Sailor et al., “Sustained Release of a Monoclonal Antibody from Electrochemically Prepared Mesoporous Silicon Oxide,” Adv. Funct. Mater. 2010, 20, 4168-4174. Although both pore size and the charge on the pore walls should have an effect on transport and binding of proteins, the transport of charged proteins within such porous silicon films has not been studied. The time dependence of protein transport in mesoporous SiO₂ films has been observed but not addressed or quantified. See, e.g., Sailor et al., “Confinement of Thermoresponsive Hydrogels in Nanostructured Porous Silicon Dioxide Templates,” Adv. Funct. Mater. 2007, 17, 1153-1162; Sailor et al., “Confinement of Thermoresponsive Hydrogels in Nanostructured Porous Silicon Dioxide Templates,” J. Am. Chem. Soc. 2005, 127, 11636-11645. In addition, explicit control of the gating mechanism is not believed to have previously been addressed.

### SUMMARY

The present invention provides electroadsorption and charged based biomolecule separation, concentration and detection with porous biosensors. In preferred embodiments, a potential is applied to a porous electrode to separate and concentrate molecules from solution. The biomolecular analytes are captured by the porous electrode itself, the same electrode that is used to generate the electric field for electroadsorption. In additional preferred embodiments, pH of the solution is adjusted to separate and concentrate biomolecules. Setting the pH equal to the protein isoelectric point was determined by the inventors to maximize concentration of biomolecules into the porous biosensor. The methods include simultaneously optically detecting charged molecules captured by the porous electrode. Methods of the invention are benign to biomolecules of interest, which are demonstrated to retain a high percentage of their activity after being released from the biosensor. Methods of the invention provide label-free detection. Advantageously, small voltages and ultrasmall volumes of solution are used in methods of the invention.

### BRIEF DESCRIPTION OF DRAWINGS

FIGS. 1A (top-plan) and 1B (cross-section) show experimental images of a porous Si sample prior to carbonization;

FIG. 1C shows a light spectrum of a carbonized pSi sample immersed in pH 6.7 buffer;

FIG. 1D shows the Fourier transformed spectrum of FIG. 1C;

FIG. 2A illustrates voltage dependent adsorption of lysozyme, specifically the percentage change in optical thickness as a function of time for a carbonized pSi film as lysozyme is adsorbed under control of electrical bias values that are applied;

FIG. 2B illustrates concentration factors representing the amount of lysozyme loaded into the carbonized pSi film relative to the bulk solution concentration;

FIGS. 3A-3C show optical responses of carbonized pSi sensors upon application of bias in the presence of lysozyme as a function of time;

FIG. 4 illustrates the percentage change in lysozyme concentration as function of applied voltage in response to discrete voltage steps from −0.5 to −2.75 V;

FIG. 5A shows current transient after application of a −0.5 V step to the pSi film and FIG. 5B shows the natural logarithm of the current vs time trace;

FIGS. 6A-6C show temporal responses of optical carbonized pSi sensors to lysozyme with applied bias as a function of ionic strength and applied bias voltage;

FIG. 7 includes data representing lysozyme activity after interaction with carbonized pSi films with electroadsorption;

FIGS. 8A-8D show the temporal optical response of a pSiO₂ film upon introduction of bovine serum albumin (BSA);

FIGS. 9A-9B show a comparison of infiltration of the proteins BSA, bovine hemoglobin (BHb) and equine myoglobin (EMb) into a pSiO₂ film;

FIGS. 10A and 10B compare the temporal response of BSA infiltration at protein isoelectric point pI=pH (4.7) and pI>pH (4.2) to theoretical curves derived from Fick's Second law;

FIGS. 11A-11C model the extent of protein infiltration and the rate at which it is admitted to a mesoporous pSiO₂ film at different pH values relative to protein isoelectric point (p1);

FIG. 12 is the IEF (isoelectric focusing) gel electrophoresis data with isoelectric pH as indicated on the left for of BSA, BHb, and EMb;

FIGS. 13A and 13B are DLS (dynamic light scattering) showing the hydrodynamic diameter of BSA, BHb, and EMb as a function of pH obtained on filtered protein solutions; and

FIGS. 14A and 14B show the influence of solution ionic strength on extent of infiltration and zeta potential of BSA.

### DESCRIPTION OF PREFERRED EMBODIMENTS

The invention provides control over the adsorption and separation of molecules via charge and via electroadsorption. Simultaneous adsorption, separation and detection can be accomplished. In embodiments of the invention, electroadsorption is used to control and enhance the admission of biomolecules into a porous sensor. In embodiments of the invention, the pH of a buffer is used to control admission of biomolecules into a porous sensor. Separation and optical detection can be simultaneously achieved.

Embodiments of the present invention provide a label-free conductive porous interferometric biosensor and sensing method that utilizes electroadsorption for analyte capture. This is advantageous because the ability to conduct biosensing without labels, e.g., dyes, tags, radisotopes, permits measurement of properties of biomolecules without interference from or effects of such labels. An important requirement of many bioassay or drug delivery applications is that the collection, concentration, and immobilization processes not denature or otherwise deactivate the biomolecule of interest, which is achieved with the label free sensing of the present invention. In addition, very small volumes can be used without concern over greatly affecting biomolecules because the eletroabsorption can be achieved with small voltages, e.g., less than 5V. Biomolecules that can be separated, concentrated and captured include nucleic acids, proteins, lipids, polysaccharides, and biological metabolites.

The present invention also provides charge-based gating/separation is of biomolecules with a porous interferometric sensor via control of molecule charge. In preferred embodiments the, pH of a buffer solution is used to control gating/separation in addition to the size of pores that provide size discrimination. Single modal size distributions can be obtained from very small sample volumes with pH used as an additional control. The process of adjusting pH may also retain activity of biomolecules that are separated.

Preferred electroabsorptoin embodiments utilize a carbonized pSi biosensor. The carbonization makes the pSi conductive. While it has been demonstrated that porous Si matrices can release antibodies, enzymes, or other biomolecules in their active form, some compositions of porous Si are known to undergo irreversible chemical reactions with drugs or other molecules. In addition, preferred embodiment carbonized matrices of the present invention are stable against chemical degradation and are electrically conductive. Unlike previous pSi matrices, the electrical conductivity combined with the chemical stability of the carbonized pSi matrix enables the electroadsorption of analytes. Other methods can also make pSi conductive, for example, by infiltration with thin metallic films or by infiltration with indium doped tin oxide.

In other embodiments, the porous film is formed of any porous semiconductor or insulator that can be suitalbly modified such that it becomes electrically or photoelectrically conductive. Preferred additional materials for the porous film include oxides of Ti, Al, Ge, Zr, and Zn, or the materials InP, GaAs, CdS, or CdSe. These materials can be made porous using established methods. Anodic etching in hydrofluoric acid solution permits control of both the porosity and thickness of porous thin film. The time of etching controls the thickness of a porous layer, while the etching current density controls the porosity. The thicknesses and porosities of thin films can be controlled in accordance with a computer generated waveform, which permits complex and predetermined multi-level porosities to be formed. These can produce complex multi-layer patterns that can selectively admit molecules and also produce codes in the reflectance is spectrum. See, e.g, “Optically Encoded Particles with Grey Scale Spectra,” Sailor et al U.S. Published Patent Application No. 20070051815.

Embodiments of the invention provide methods and devices for simultaneous separation, capture, and detection of molecules. A preferred device includes and a preferred method uses a carbonized, porous nanostructure. The porous nanostructure provides an electroadsorptive substrate that is both conductive and semitransparent. Separation can be accomplished by diffusional transport within the porous nanostructure. Capture can be accomplished by electroadsorption via electrification of the nanostructure. Detection can be accomplished by optical interferometry. Devices and methods of the invention advantageously detect and manipulate molecules in the same physical location that is an ultrasmall volume defined by the nanopores of the carbonized, porous nanostructure. An ultrasmall volume is between 50 nL and 0.001 nL.

Preferred pH gating embodiments utilize a pSi, pSiO₂, or partially oxidized pSi sensor having pores sufficiently small that they are capable of discriminating between isolated proteins and protein aggregates. Control of the pH of a buffer solution can control the separation and transport of molecules into the pores. This can also be achieved with ultrasmall volumes.

Preferred embodiments of the invention will now be discussed with respect to experiments and with respect to experimental data and the drawings. The drawings may include schematic representations, which will be understood by artisans in view of the general knowledge in the art and the description that follows. Features may be exaggerated in the drawings for emphasis, and features may not be to scale.

### Electro-Adsorption Based Adsorption Detection and Sensing.

A preferred embodiment of the invention is an electrically addressable optical biosensor that allows simultaneous separation, capture, and detection of proteins within the same ultrasmall physical volume (e.g., <50 nL). A device of the invention includes a high surface area, highly porous optical is carbonized porous electrode with a porous nanostructure that provides an optical response. In preferred embodiments, the electrode is a carbonized porous Si Fabry-Perot film. Applied electrical potential can concentrate protein molecules from a solution into the pores of the electrode. The applied voltage magnitude can be small, e.g., less than 5V, and the adsorption can be achieved with the biosensor itself acting as an electrode without destroying activity of biomolecules that are admitted into the sensor. The biosensor and method are highly effective at concentrating an analyte biomolecule of interest.

For example, in experiments, an applied electric potential in the range of −0.01V to −10 V induces concentration of the positively charged test protein lysozyme within the porous nanostructure to a level of up to 9600 times the free solution concentration. Diffusion and adsorption of protein within the ˜40 nm-diameter pores of an experimental device in accordance with the invention were monitored simultaneously by optical interferometry, providing the ability to identify the protein based on its characteristic charge/size/diffusion characteristics. A captured protein can be held for several hours, and can be released from the porous nanostructure electrode when the electrode is returned to zero bias. The released protein retains its enzymatic activity, and the optical electrode can undergo multiple adsorption/desorption cycles.

The particular example systems in the experiments regarding the invention that are discussed below were not applicable to negatively charged molecules due to a lack of stability of the carbonized pSi sensor under positive bias conditions, although this is not a fundamental limitation of the carbon electrode. A sensor in accordance with the invention for negatively charged particles can be realized with more stable carbonization chemistries for porous Si, which have been developed with one of the present inventors (such as is formed by pyrolysis of organic infiltrates; see, e.g., Kelly, T. L.; Gao, T.; Sailor, M. J., “Carbon and Carbon/Silicon Composites Templated in Microporous Silicon Rugate Filters for the Adsorption and Detection of Organic Vapors.” Advanced is Materials, 2011, 23, 1776-1781), as these chemistries should be applicable to voltage dependent diffusion and adsorption experiments. Details of the stable carbonization chemistries that can be used are found in Sailor et al., “Carbon and Carbon/Silicon Composites Templated in Rugate Filters for the Adsorption and Detection of Organic Vapors,” Advanced Materials, Vol. 23, Issue 15, pp 1776-1781 (Apr. 19, 2011). A significant advantage of carbonaceous surfaces is their compatibility with biological systems. The biocompatibility has been demonstrated with carbon nanotubes. See, e.g., Maehashi et al., “Label-Free Protein Biosensor Based on Aptamer-modified Carbon Nanotube Field-Effect Transistors,” Anal. Chem. 79, 782-787 (2007); Hrapovic, S., “Electrochemical Biosensing Platforms using Platinum Nanoparticles and Carbon Nanotubes,” Anal. Chem. 76, 1083-1088 (2004); Sotiropoulou, S., “Carbon Nanotube Array-Based Biosensor,” Anal. Bioanal. Chem. 375, 103-105 (2003). Experiments to demonstrate the invention have shown that the functional activity of lysozyme after release from pores of a carbonized p-Si sensor after electroabsorption.

In these experiments, a carbonized porous Si (pSi) layer is used as an electroadsorptive substrate. The high surface area of this three-dimensional material provides for capture and concentration of significant quantities of protein. By preparing the carbonized pSi matrix as a conductive but semitransparent thin film, its optical response provides the ability to detect and identify biomolecules simultaneous with, and in the same physical location as, the separation event within the ultrasmall volume of the thin film.

Example devices of the invention were prepared by the controlled electrochemical etch of single crystal Si, porous Si films can be designed with pore sizes ranging from 1 to several hundred nm, allowing size-selective filtration or separation of a wide range of molecular species. See, e.g., Sailor et al. U.S Published Patent Application 20070108465, published May 17, 2007, and entitled Porous Microstructure Multi-layer Spectroscopy and Biosensing, which discloses fabricating and using a multi-layer structure with pores sized to accept different is molecules of interest in different layers in multi-layer spectroscopy with porous biosensors.

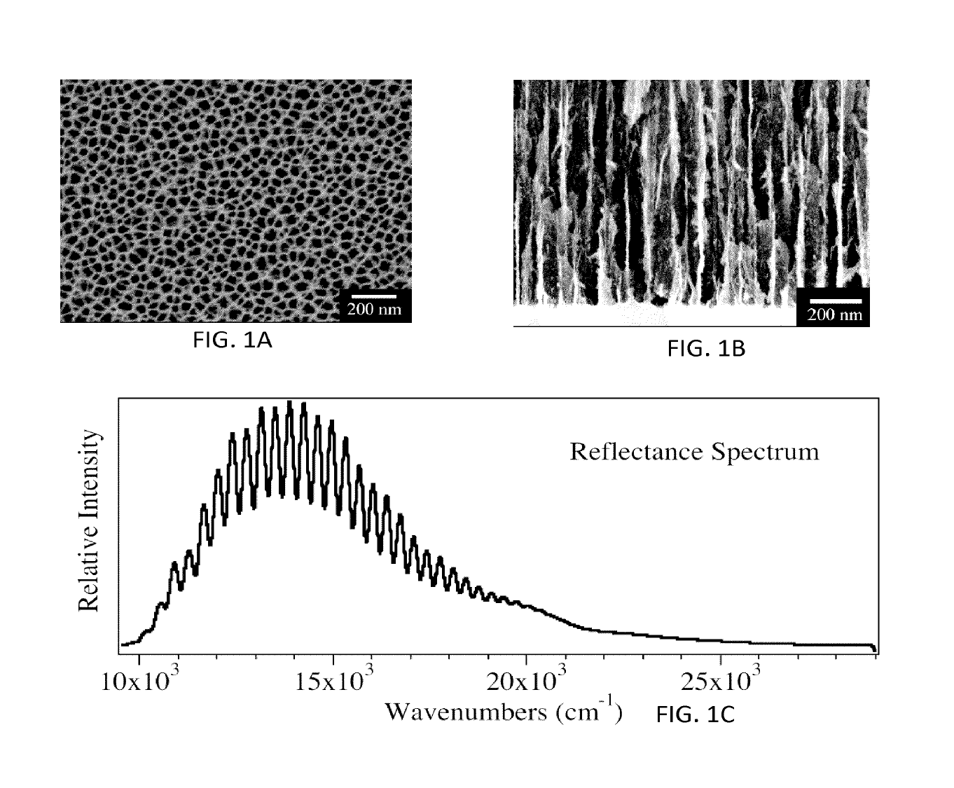

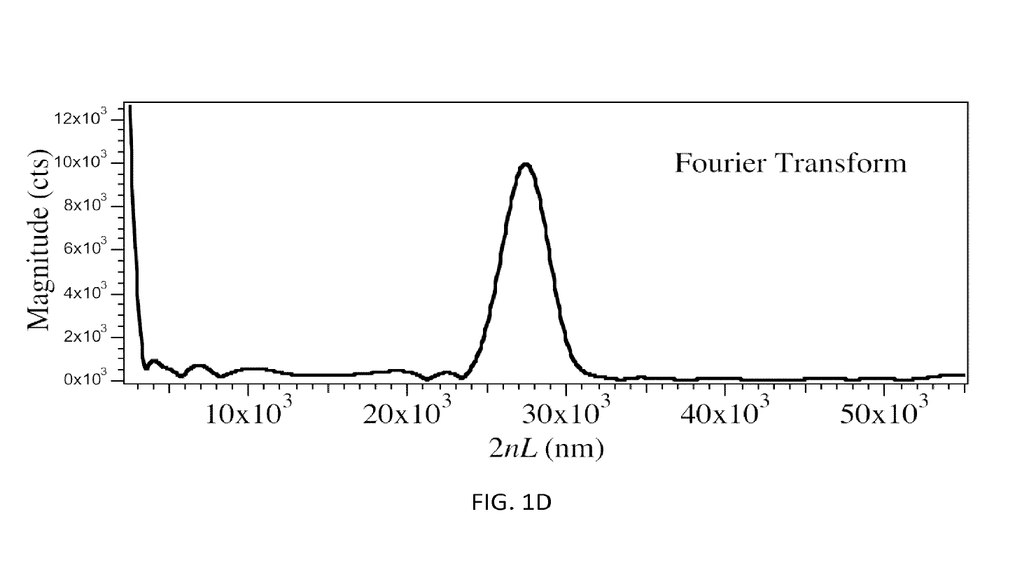

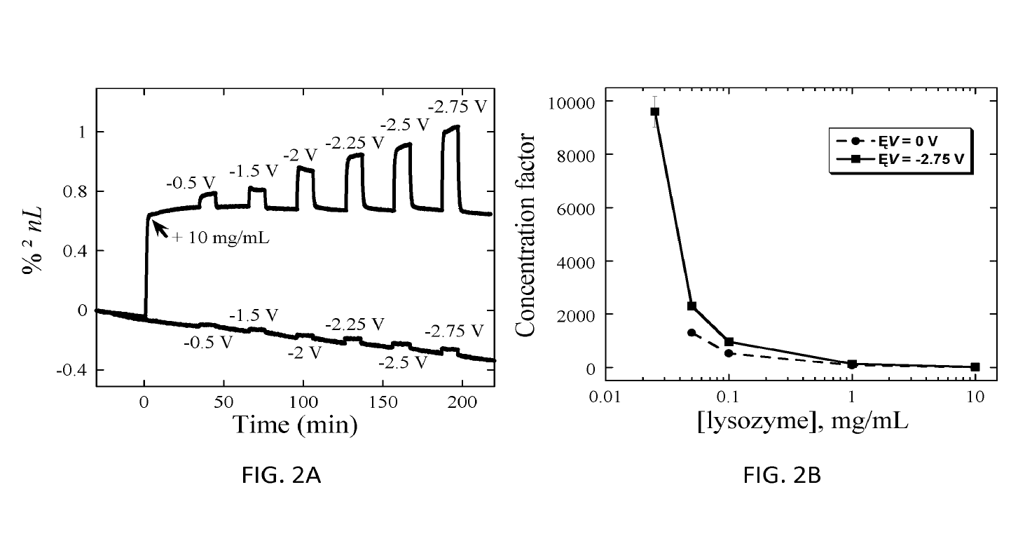

In the present experiments, a 9.8 μm thick pSi film with nominal average pore diameters of 40 nm was prepared (FIGS. 1A-1B). The porosity was 73% and the pores are parallel to each other and propagate in the <100> direction, orthogonal to the face of the Si substrate. The chemical stability of as-formed pSi films is poor, and most biosensor applications of pSi films require thermal oxidation of the matrix prior to use. Silicon oxide is an electrical insulator that is not suitable for the electroadsorption to conduct electroadsoprtion.

The pSiO₂ was converted into a porous nanostructured electrode via carbonization. A conductive carbon coating was applied to the pSi surface using a thermal carbonization route developed by Salonen. See, Salonenet al., “Stabilization of Porous Silicon Surface by Thermal Decomposition of Acetylene,” Appl. Surf. Sci. 225, 389-394 (2004). Synthesized by high-temperature decomposition of acetylene gas on as-formed pSi, this surface has been shown to be stable in aqueous media and amenable to optical biosensor applications. See, Sailor et al, “Bioconjugate Functionalization of Thermally Carbonized Porous Silicon using a Radical Coupling Reaction,”. Dalton Trans. 39, 10847-10853 (2010).

In the experiments described herein, the carbonization reaction generated a partially transparent, slightly hydrophobic surface (contact angle ca) 90° that was readily infiltrated by aqueous solutions. The pore dimensions in the carbonized pSi samples are smaller than optical wavelengths, and so the thin films displayed Fabry-Pérot optical interference fringes in the white light reflectance spectrum (FIG. 1C). FIG. 1C specifically shows the reflected light spectrum of carbonized pSi sample immersed in pH 6.7 buffer, and the spectrum reveals the characteristic Fabry-Pérot interference fringes. The sample was illuminated with focused white light, and reflected light was collected through the same lens positioned along an axis normal to the sensor surface and then transmitted to a is CCD spectrometer.

This interference spectrum provided the ability to perform label-free detection of biomolecules that entered the film, based on characteristic changes in the refractive index of the porous medium. See, e.g., Ghadiri et al., U.S. Pat. No. 6,897,965, May 24, 2005 entitled Porous Semiconductor Based Optical Interferometric Sensor. The observed interference spectrum is determined by the average refractive index, n, and the physical thickness, L, of the pSi sample via the Fabry-Pérot relationship. The value nL was determined from the Fourier transform of the spectrum (FIG. 1D). The transform yields a single peak whose position along the x-axis is equal to the value 2 nL (product of average refractive index and thickness of the film) For the biosensing experiments, changes in nL corresponding to entry or exit of protein from the pSi layer were recorded in real time using a fast CCD-based spectrometer.

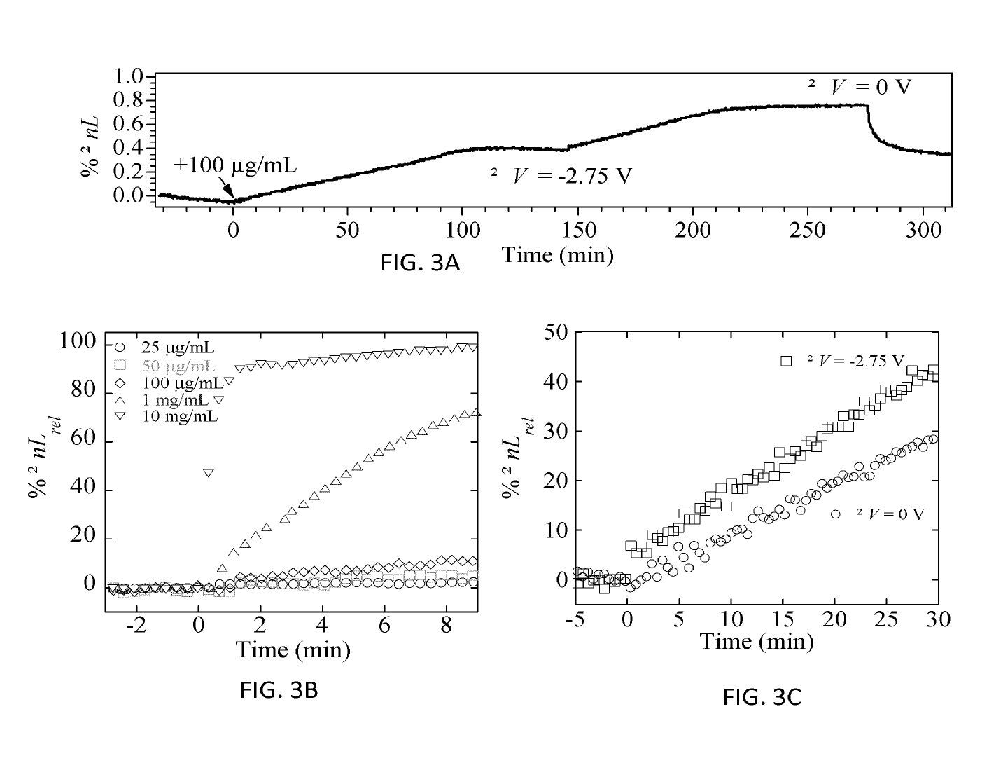

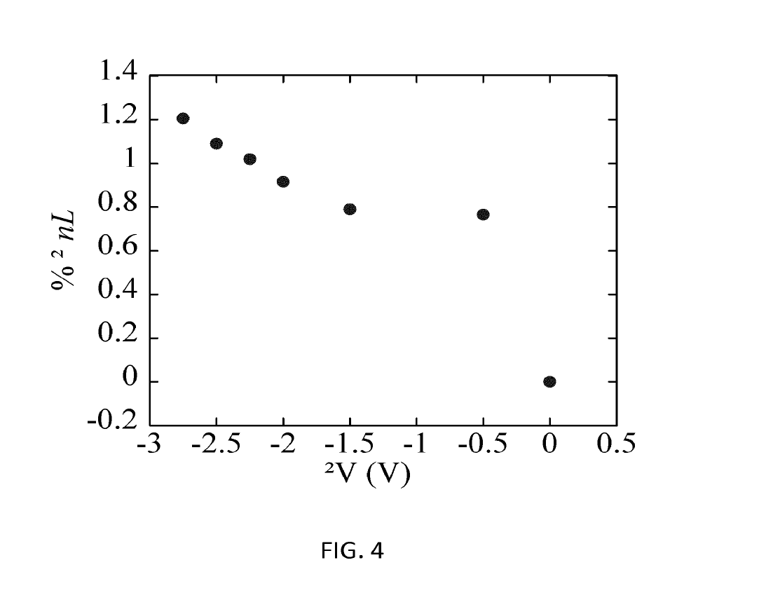

Lysozyme (14 kDa, isoelectric point ˜pH 11) was selected as a test protein in experiments to demonstrate the invention. At pH=6.7, lysozyme exhibits a net positive charge. When the carbonized pSi film was held at a negative potential relative to a Pt counter electrode in the presence of aqueous lysozyme at pH=6.7, the optical response of the carbonized pSi film indicated significant accumulation of protein within the carbonized pSi matrix. The potential-dependent response is reported in FIGS. 2A and 2B in terms of the percent change in nL,

$$\% Δ nL = \frac{{nL}_{t , Δ V} - {nL}_{t - 0 , Δ V = 0}}{{nL}_{t = 0 , Δ V = 0}} \times 100 \qquad ( 1 )$$

where nL_{t,DV} is measured at a given time t and applied bias DV; nL_{t-0,DV-0} is the value of nL measured from the sample in pure buffer solution at a time immediately prior to introduction of protein (t=0) and at an applied bias (DV) of 0 V relative to the Pt counter electrode. FIG. 2A shows the change in optical thickness as a function of time. The top trace represents the optical is response of the sensor after introduction of 10 mg/mL lysozyme at time t=0, the bias values (ΔV) applied, relative to a Pt counter electrode, are indicated. The bottom trace represents the control experiment in pure buffer, without added lysozyme. FIG. 2B shows concentration factors representing the amount of lysozyme loaded into the pSi film relative to the bulk solution concentration, calculated from eq. 3, as a function of bulk solution concentration of lysozyme. Data for two values of ΔV are shown. Lysozyme loading values calculated from the optical data, assuming protein density of 1.36 g/mL and refractive index of 1.55, values that were obtained from published literature.

As seen in the data, at a bias of 0 V in pure pH 6.7 buffer, a small, steady decrease in the baseline value of % ΔnL was observed, indicative of slow oxidation and dissolution of the carbonized pSi matrix. Lysozyme (10 mg/mL) was introduced to the flowing buffer solution after 30 min, which resulted in an instantaneous increase in the value of % ΔnL as protein infiltrated the pSi matrix. After a steady-state value was reached, the negative bias on the pSi sample was increased in a series of discrete steps, from −0.5 to −2.75 V. Bias was maintained at a given value for 10 min, after which the bias was returned to 0 for 20 min. An increase in the value of % ΔnL was observed that was proportional to the applied negative bias (slope=−0.2 percent/V) and the value returned to the baseline when the bias was set back to 0 V. Control experiments using buffer solution that contained no protein (FIG. 2A) or an anionic protein (bovine serum albumin, BSA) displayed minimal response. The results are consistent with a voltage dependent protein adsorption/desorption process: adsorption of protein to the pore walls of the electroactive pSi matrix depletes the solution within the pores of protein, setting up a concentration gradient Infiltration of additional protein from the bulk solution then generates the observed increases in the value of % ΔnL.

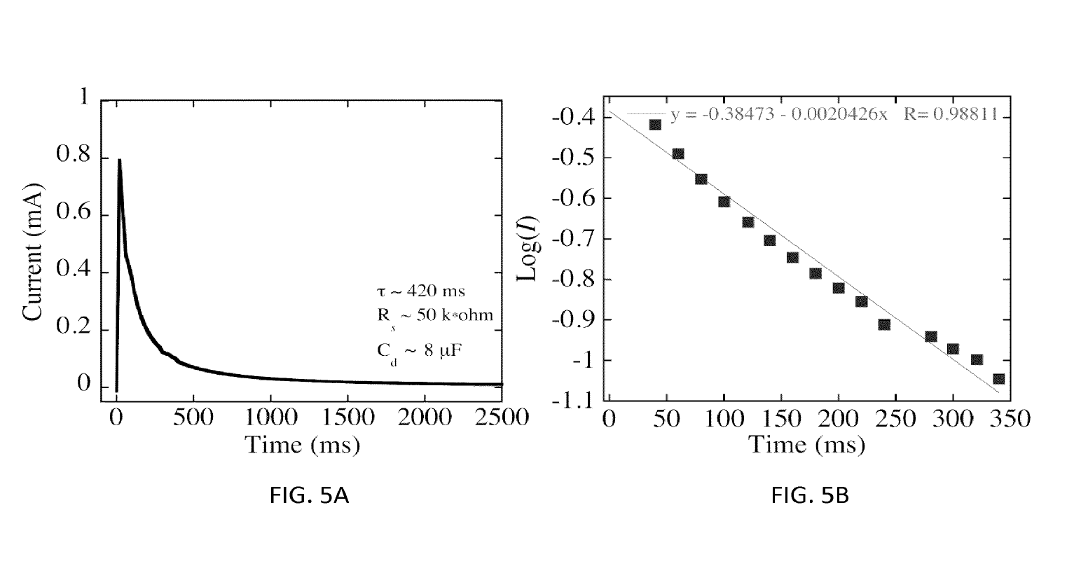

The protein displays time dependent transport within the carbonized pSi matrix that is sensitive to concentration and applied voltage. At zero applied is bias, the sensor required ˜10 min to reach a steady-state value when the concentration of lysozyme introduced was 10 mg/mL, and ˜2.5 h when the concentration of lysozyme was 0.1 mg/mL (FIG. 3A). The interfacial capacitance of the device was measured to be 8 μF/cm²; the time constant for a 0.5 V (non-Faradaic) voltage step was ˜0.4 sec. For the purposed of comparing characteristic timescales, the percent change in nL relative to the steady state values was defined as

$$\% Δ {nL}_{rel} = \frac{{nL}_{t , Δ V} - {nL}_{t = 0 , Δ V = 0}}{{nL}_{t = ∞ , Δ V} - {nL}_{t = 0 , Δ V = 0}} \times 100 , \qquad ( 2 )$$

where nL_{t,DV} and nL_{t=0,DV=0} are as defined above and nL_{t=¥,DV} is the equilibrium value of nL measured in the presence of lysozyme and with applied bias DV.

FIG. 3A shows the optical response, % ΔnLᵣₑₗ, as a function of time after lysozyme (100 μg/mL) was introduced at time t=0s. At t=140 min, ΔV was switched from 0 to −2.75 V. At t=280 min, ΔV was switched back to 0. FIG. 3B is an expanded view of % ΔnLᵣₑₗ vs time, showing the temporal response of the film upon application of a step in applied bias in the presence of the indicated concentrations of lysozyme. For each trace, ΔV was switched from 0 to −2.75 V at time t=0. FIG. 3B is a comparison of % ΔnLᵣₑₗ vs time profiles for addition of 100 μg/mL lysozyme to the carbonized pSi chip, held at ΔV values of 0 and −2.75 V as indicated.

As shown in the data, application of a bias of DV=−2.75 V to a chip that had equilibrated with 0.1 mg/mL of lysozyme at DV=0 resulted in a doubling of the quantity of protein in the porous matrix (FIG. 3A). When DV was returned to a value of 0, lysozyme diffused out of the matrix and the sensor returned to the original equilibrated (DV=0) value. The temporal response of the film under negative bias was highly dependent on protein concentration (FIG. 3B). For a given value of DV, the approach to equilibrium after introduction of lysozyme was slower at lower concentrations of the protein. These observations are in is accordance with Fick's second law, which describes the time-dependent mass transfer of molecules in a concentration gradient. The approach to equilibrium was faster with a higher negative the applied bias (FIG. 3B), which can be attributed to the larger analyte concentration gradient induced by the more negative applied bias (FIG. 2B). These data support using the time and bias dependence of the voltage-induced transport phenomenon to identify molecules based on their diffusional characteristics.

The total quantity of protein adsorbed on the carbonized pSi electrode increased with more negative values of DV. A concentration factor (CF), defined as the ratio of the mass of protein in the carbonized pSi film per unit volume to the mass of free protein remaining in the bulk solution per unit volume (eq. 3) was determined from the measured equilibrium nL values for various values of the bulk solution concentration of lysozyme.

$$C F = \frac{{[ lysozyme ]}_{pores}}{{[ lysozyme ]}_{solution}} \qquad ( 3 )$$

The concentration factor increases with negative applied bias and with lower concentrations of lysozyme in the bulk solution (FIG. 2B). For bulk solution concentrations of 25 μg/mL (the lowest concentration studied), lysozyme was not detectable at zero applied bias. However, with an applied bias of DV=−2.75 V, significant accumulation of protein was observed; the optical data indicated that 91 mg/mL of lysozyme accumulated in the pSi film, which reduced the total bulk solution concentration of lysozyme to 9 μg/mL, or a concentration factor of 9600.

These protein concentration values were verified using a standard protein assay (micro BCA); the carbonized pSi film was digested in aqueous NaOH (1M) overnight, the supernatant was neutralized with aqueous HCl (1M) and subjected to the assay. The assay yielded a protein concentration in the pSi is film of 86 mg/mL, in good agreement with the optical measurements. Whereas the total quantity of protein admitted into the carbonized pSi film scaled with the bulk solution concentration, the concentration factor increased with decreasing protein concentration in the bulk solution, such that the greatest degree of partitioning into the carbonized pSi film occurred at the lowest values of bulk solution concentration (FIG. 2B).

A characteristic of electroadsorption is that the magnitude and sign of the charge on the ion exerts a strong influence on the extent of adsorption. This property has been previously recognized. See, Wandlowski et al, “Structure and Stability of Cytosine Adlayers on Au(111): An in-situ STM Study,” J. Electroanal. Chem. 404, 215-226 (1996). This was manifested in the experiments described herein by the magnitude of % DnL. Control experiments using bovine serum albumin (BSA) yielded no significant response in % DnL when the value of DV was switched between 0 and −2.75 V. BSA carries a net negative charge at pH 6.7, and so the data are consistent with an electroadsorption phenomenon driving protein diffusion into the pores. BSA would be expected to adsorb to a pSi electrode held at a positive bias. However, the carbonized pSi samples exhibited significant corrosion at values of DV≧0 (FIG. 2A), and no evidence of electroadsorption of BSA could be observed at positive bias values due to the instability of the carbonized pSi electrode with positive bias voltages.

TABLE S1
Dependence of lysozyme concentration factor on ionic strength.^{a}

| | I = 50 mM | I = 100 mM | I = 150 mM |
|---|---|---|---|
| CF, ΔV = 0 V | 69 | 82 | 100 |
| CF, ΔV = −2.75 V | 110 | 130 | 140 |

^{a}Concentration factor CF, as defined in eq. 3 in the text. Ionic strength (I) corresponds to total electrolyte concentration in the solution. Free lysozyme concentration (in solution) was 1 mg/mL

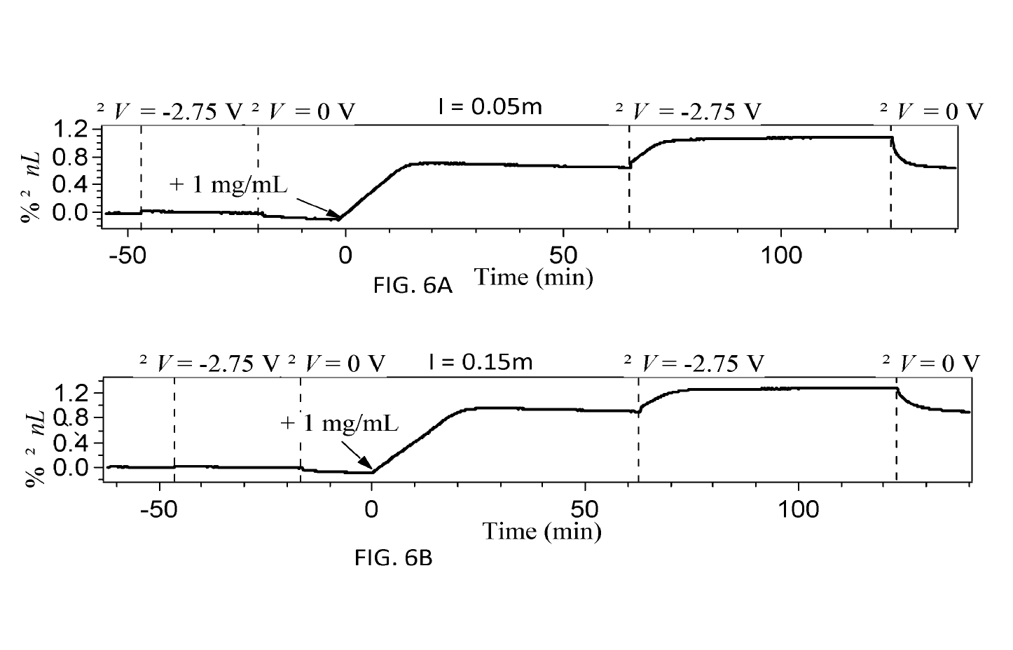

FIG. 4 shows % ΔnL as a function of applied voltage (ΔV). Sensor response to discrete voltage steps, from −0.5 to −2.75 V, preloaded with 10 mg/mL lysozyme. The data show that the increase in % ΔnL is proportional to applied negative bias with a slope of −0.19 percent/V.

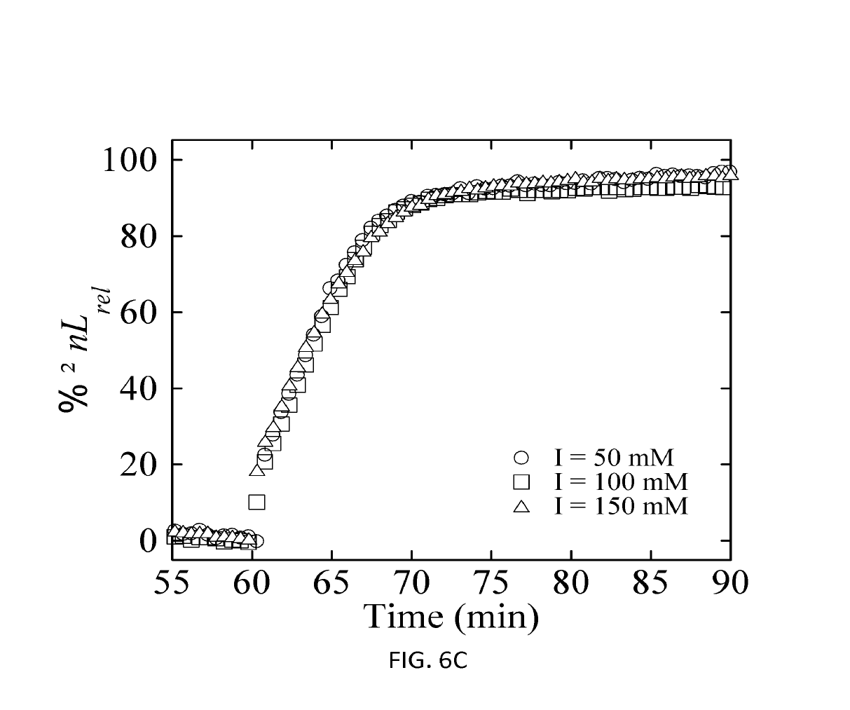

FIG. 5A shows the current transient (I vs t) resulting from a −0.5 V non-Faradaic potential step after application of a −0.5 V step to the pSi film. The electrolyte contained buffer at an ionic strength of 0.007 M. The natural logarithm trace of the current vs time trace was used to calculate interfacial (double layer) capacitance, C_{d} (based on τ=RₛXC_{d}). Based on three replicate −0.5 V steps, the average time constant, τ was 420 ms, the resistance of the cell was 42 kΩ/cm², and interfacial capacitance was 8 μF/cm².

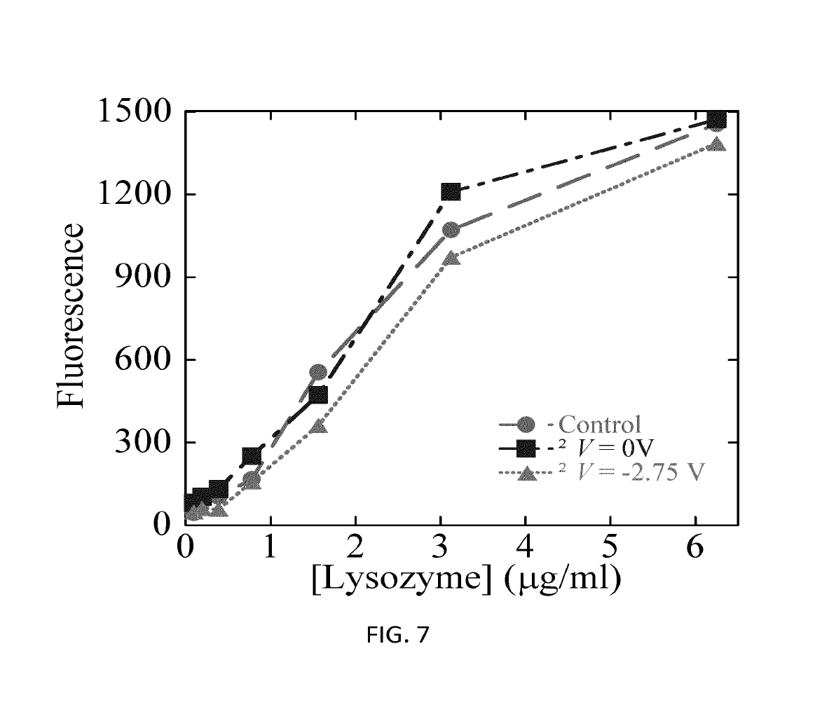

FIGS. 6A and 6B respectively show optical responses of carbonized pSi film for ionic strengths of 0.05M and 0.150M. In each case, the optical response of a sample is shown after introduction of 1 mg/mL lysozyme at time t=0 with an applied bias of −2.75 V at time ˜60 min. At time ˜120 min, bias was returned to 0 V, resulting in a decrease in the optical response. For both experiments, initial baseline was achieved in pH 6.7 buffer with ionic strength=0.05 M (FIG. 6A) or 0.150 M (FIG. 6B) and ΔV=−2.75 around time ˜−45 min for 30 min followed by ΔV=0 for 15 min. FIG. 6C shows the temporal response of the film with an applied bias ΔV=−2.75 for the indicated values of ionic strength. For this experiment, the bias ΔV=−2.75 V was applied at time t=0. The y-axis label, % ΔnLᵣₑₗ, is as defined in Eqn. (2).

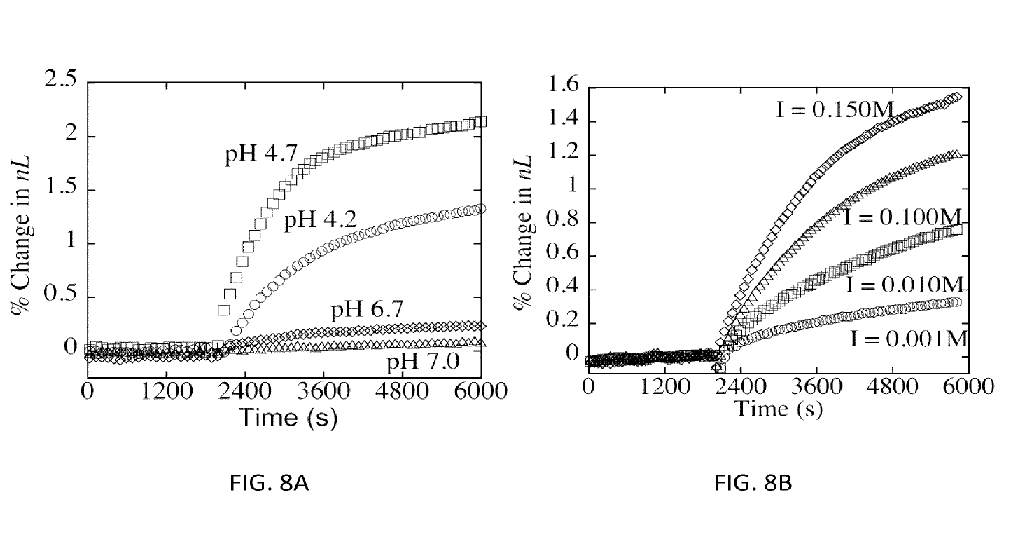

The activity of lysozyme after the voltage controlled interaction in carbonized porous films was measured, and the data is shown in FIG. 7. The lysozyme activity was measured by incubating lysozyme with Micrococcus lysodeikticus cell walls labeled with fluorescein. Fluoresence is quenched in the cell wall, and the action of active lysozyme disrupts the cell walls and releases fluorescein into solution, where its fluorescence recovers. Fluorescence is thus proportional to lysozyme activity. Here, the fluorescence was measured after 30 min of incubation with the lysozyme solution samples. Three different samples are compared in FIG. 7: control (as-received), lysozyme that had been exposed to the carbonized porous silicon sample at ΔV=0 V, and lysozyme that had been loaded into carbonized pSi at an applied bias of ΔV=−2.75 V for 120 min and is then released into free solution. Concentration of lysozyme (x-axis) was determined independently by BCA assay. Based on the mean percent error of samples obtained at ΔV=−2.75 V vs. control samples, Lysozyme retains ˜81% activity after the experiment.

Experimental Details for Electroabosprtion—Carbonized pSi Materials. Aqueous HF (48%) and ethanol (99.9%) were supplied by EMD and Gold Shield Chemical Company, respectively. Porous Si samples were prepared from highly doped p-type Si with resistivity ranging from 0.0008-0.001 Ω-cm (polished on the (100) face, boron doped, from Siltronix Corp). Chicken lysozyme (Lys, 14 kDa) was obtained from Sigma-Aldrich, Cat. No. L6876. The protein was used as-received without further purification. 5 mM buffer solutions were prepared by mixing ultrapure (18 MW) water with monobasic sodium phosphate (Fisher Scientific, Cat. No. S369-500). The pH was adjusted by addition of small quantities of aqueous HCl or NaOH. The ionic strength of the prepared buffer solutions ranged from 0.001 to 0.15 M. Lysozyme activity assay and bicinchoninic acid assay kits were received from Invitrogen, Cat. No. E33013 and Thermo Scientific, Cat. No. 23235, respectively. Protein assay kits were used as-received.

Porous Silicon Preparation and Characterization. Porous Si samples were anodically etched in a 3:1 solution of aqueous 48% HF:ethanol. Si chips with an exposed area of 1.2 cm² were contacted on the back side with a strip of aluminum foil and mounted in a Teflon etch cell. Samples were then electrochemically etched in a two-electrode configuration using a platinum mesh counter electrode. Single-layer samples were prepared by application of a current density of 467 mA/cm² for 48 s. Samples were rinsed three times with ethanol and then dried with nitrogen gas. Porosity was characterized using the nondestructive spectroscopic liquid infiltration method (SLIM).

Thermal Carbonization. Porous Si samples were thermally carbonized in a tube furnace (Lindberg/Blue M) at 450° C. for 30 min with a constant flow of acetylene and nitrogen gas at a flow rate of 1 L/min and allowed to cool to room temperature in a nitrogen atmosphere.

Interferometric Reflectance Spectra Collection and Data Processing. Reflectance spectra were recorded with an Ocean Optics USB-4000 CCD spectrometer coupled to a bifurcated fiber optic cable. A tungsten halogen light source was used to illuminate the surface of the sample via one arm of the bifurcated fiber. Both the spectral acquisition and light illumination were performed along an axis normal to the surface of the pSi sample. The optical thickness quantity nL (where n=average refractive index and L=sample thickness in nm), was obtained from the Fast Fourier Transform (FFT) of the acquired reflectance spectrum. Details on conducting this transform can be found in Sailor et al. U.S. Published Application No. US 20110170106, Published Jul. 14, 2011, entitled Multiple Superimposed Interface Pattern Microstructure Multi-Layer Biosensing Method.

Time-Resolved Biosensing Experiments. Buffer solutions with ionic strength ranging from 0.007 to 0.15 M, and pH values of 6.7, were used in the experiments to study the effect of ionic strength on protein loading. In the experiments to quantify loading and concentration efficiency as a function of applied bias and bulk solution protein concentration, buffer solutions (pH 6.7) with ionic strength of 0.007 M was used. Optical data were acquired using a custom-designed flow cell system fitted with a platinum electrode and an optically transparent window to facilitate acquisition of reflectance spectra. The counter electrode was a loop of platinum wire, and the carbonized pSi working electrode was contacted on the backside with a strip of aluminum foil. In a typical experiment, spectra were acquired every 10 s and an initial baseline was established in pure buffer solution (flow rate ˜1 mL/min) A solution containing is 5 mL of the protein of interest, dissolved in the identical buffer, was then introduced to the flow cell (flow rate ˜1 mL/min) and spectral data were acquired until equilibrium was established. The buffer solution was circulated in a closed loop during data acquisition (total solution volume=5 mL).

Lysozyme Activity Study. Three lysozyme solution samples were assayed: (1) buffered solution (pH=6.7) containing as-received lysozyme, (2) similarly buffered solution containing lysozyme that had been circulated in the flow cell containing a carbonized pSi film held at an applied bias of 0V relative to the Pt counter electrode, and (3) buffered solution containing lysozyme that had been circulated in the flow cell containing a carbonized pSi film held at an applied bias of −2.75 V relative to the Pt counter electrode. After 120 min, the applied bias was changed to 0 V and the solution allowed to circulate for an additional 60 min to ensure equilibration of the released lysozyme. The solutions were collected from the flow cell and incubated at 37° C. with the lysozyme assay reagents. Fluorescence was measured on a microplate reader using excitation/emission wavelengths of 485/530 nm at five different time points (30, 60, 90, 120, and 150 min).

The ionic strength of the electrolyte exerted only a minor effect on electroadsorption. The equilibrium quantity of lysozyme adsorbed at the pSi electrode increased slightly upon increasing the ionic strength, and the rate at which it achieved equilibrium (at pH 6.7) was unaffected for electrolyte concentrations in the range 0.007-0.15 M. Thus the mechanism of transport of protein in the electrified carbonized pSi matrix can be attributed to diffusion along a concentration gradient that is driven by electroadsorption of protein within the electrical double layer, rather than electrical field-driven ion migration such as that observed in electrophoresis.

### Charged-Gated Transport

Other embodiments of the invention concern charged based gating of is biomolecules into porous films, which can be used alone or in addition to the electroadsorption methods discussed above. The admission into and diffusion through nanoscale pores by molecules is a fundamental process of great importance to biology and separations science. Systems (e.g., chromatography, electrophoresis) designed to harness such processes tend to remove the separation process from the detection event, both spatially and temporally.

Preferred embodiments have been demonstrated experimentally. The charge of molecules and the pore size of porous films were used to separate, isolate and detect molecules of interested. Porous films described above can be used. Additional embodiments that were tested experimentally utilized p-SiO₂ films.

In the experiments, thin optical Fabry-Pérot sensor films of mesoporous silica (p-SiO₂) were shown to detect protein infiltration by optical interferometry, which probes the separation process in real time and in ultrasmall physical volumes (e.g., 5 nL). Admission of a protein into the pores is controlled by the diameter (e.g., less than 100 nm and in experiments ˜50 nm) and the surface charge of the pores, and both the rate and the degree of protein infiltration is a function of solution pH that provides additional controlled gating of the biomolecules into the sensor. Test proteins bovine serum albumin (BSA, 66 kDa), bovine hemoglobin (BHb, 65 kDa) and equine myoglobin (EMb, 18 kDa) are admitted to or excluded from the nanophase pores of this material based on their size and charge. The rate of protein transport within the pores of the p-SiO₂ film is slowed by 3 orders of magnitude relative to the free-solution diffusion values, and it is maximized when pH=pI (protein isoelectric point).

The surface charge on a protein is determined by the chemical identity of the exposed residues and by the pH of the solution. The charge on a protein can be characterized by its pI value; when pI=pH, the net ionic charge on the protein is zero.

Size and pI data are summarized in Table 2 (as obtained from is published literature). The radius was obtained by dynamic light scattering measurements of non-aggregated proteins at pH 7.5. The surface of pSiO₂ has a net negative charge at pH>2, and electrostatic attractions will cause a positively charged protein to nonspecifically bind to this surface.

TABLE 2
Protein properties.

| | Molecular | Dimensions | Hydrodynamic | |
|---|---|---|---|---|
| Protein | Mass (kDa) | (nm)^{a} | radius (nm) | pI |
| bovine serum | 66 | 14 × 3.8 × 3.8 | 7.1 | 4.7 |
| albumin (BSA) | | | | |
| bovine | 65 | 6.3 × 8.4 × 5.4 | 7.4 | 6.8 |
| hemoglobin | | | | |
| (BHb) | | | | |
| equine | 18 | 4.5 × 3.5 × 2.5 | 4.2 | 6.7, 7.3 |
| myoglobin | | | | |
| (EMb) | | | | |

As described above, for optical interference sensing, value nL is determined from the Fabry-Pérot relationship, mλ=2 nL, where λ is the wavelength of maximum constructive interference obtained from the reflectivity spectrum and m is the spectral order of a particular interference fringe maximum. The n values were determined by Fourier transform of the optical reflectivity spectrum as described above. When immersed in a buffer solution, the value of n corresponds to a nonlinear average of the index of the pSiO₂ matrix and the buffer. The proteins used in the experiment have a refractive index that is larger than that of water, so infiltration of protein typically results in an increase in the measured value of nL. Typical samples had thickness of 5.7 μm, with a porosity of 80% and average pore diameter 50 nm.

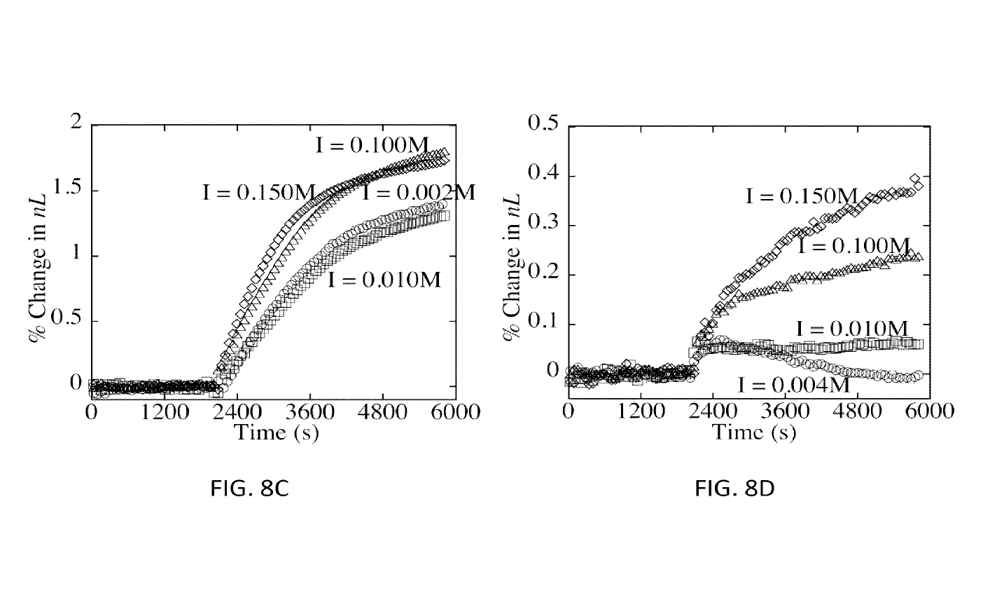

FIGS. 8A-8D show the temporal optical response of a pSiO₂ film upon introduction of BSA. Experiments were performed at pH=4.2 (FIG. 8A), 4.7 (FIG. 8B), 6.7 (FIG. 8C), and 7.0 (FIG. 8D). The diffusion profiles are highly is pH dependent, with very little BSA entering the pores at pH values greater than the pI of BSA (4.7), and the most BSA entering the pores at pH=pI. The data are consistent with an electrostatic binding process: the negatively charged pSiO₂ surface binds larger quantities of BSA when the protein is positively charged compared to when it is negatively charged.

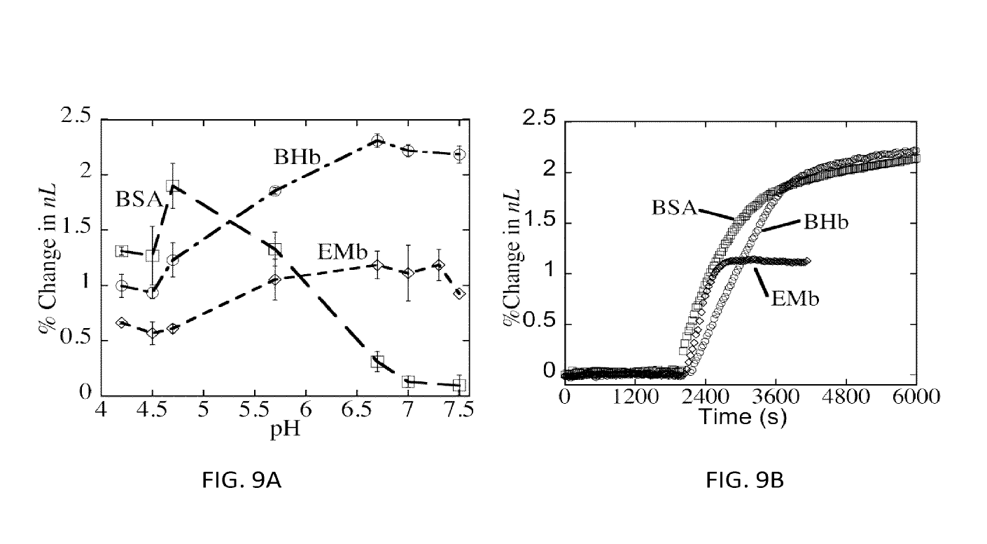

Analagous pH behavior is observed with the other two proteins studied, and the results are summarized in FIGS. 9A and 9B. FIG. 9A shows equilibrium percent change in nL as a function of solution pH for the three proteins. The results correlate with protein isoelectric point. Dashed lines are included as a guide to the eye. FIG. 9B shows optical responses of a pSiO₂ sensor to the indicated proteins as a function of time. For each protein, the experiment was performed at a solution pH equal to the pI of that protein: pH 4.7 (BSA), pH 6.8 (BHb), or pH 6.7 and 7.3 (EMb). Proteins introduced at t=2000 s. All measurements performed with 1.0 mg/mL protein concentration in 0.01 M buffers. The percent change in nL is found to reach a maximum at the pI value of the protein. For example, the peak in the value for BSA occurs at pH=4.7, consistent with the published pI value for this protein. BHb displays a maximum percent change in nL at pH˜6.7, although the transition is not as sharp as with BSA. EMb displays an even broader transition, with a maximum occurring in the pH range 5.7-7.3. The broad transitions observed in the pSiO₂ film experiments for BHb and for EMb are consistent with the IEF results reported below in the experimental details and in the literature. The IEF results for BHb display a broad streak spanning a range of values from pH 6.8-7.4 that is consistent with the optical data. The data for BHb suggest that conformational changes, denaturing, or agglomeration of protein occurs under the conditions of the experiment. EMb has been found in published research to contain two different components with different structures, and the IEF measurement yields two distinct values for pI, at pH 6.7 and at pH 7.3. The pSiO₂ optical measurement of this protein displays a broad maximum that spans these two pI values.

The data of FIG. 9B also reveals information on the rate of transport of each protein in the porous layer. The EMb protein reaches the equilibrium binding point within 10 min, much more rapidly than the two larger proteins BSA and BHb. This result can be interpreted in terms of the physical size of the protein and its molar concentration. The Stoke-Einstein equation describes spherical particles diffusing in an aqueous solution. The diffusivity of a dilute suspension of spherical colloid particles, D, is expressed as

$$D = \frac{κ T}{6 {πμ}_{B} r} \qquad ( 4 )$$

where k is Boltzmann's constant, T is temperature, μ_{B} is the viscosity of the solution, and r is the hydrodynamic radius of the particle. Thus, proteins with smaller hydrodynamic radii are expected to show larger diffusivity in free solution. In the present experiments all protein solutions were studied at concentrations of 1 mg/mL; thus the molar concentration of EMb is nearly four times larger than the other two proteins. According to Fick's Second law of diffusion, this larger concentration gradient will yield a larger observed rate of diffusion.

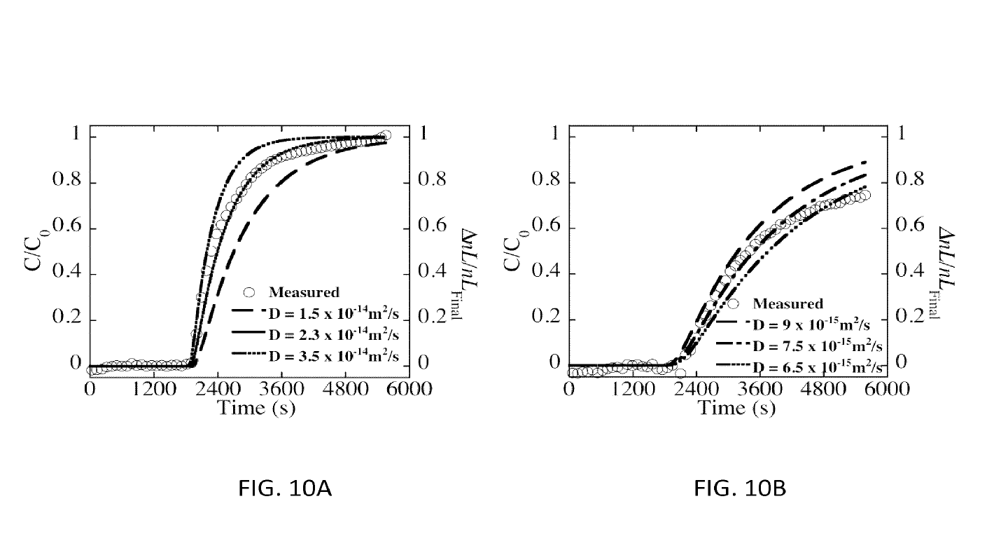

The pH of the buffer solution exerts a pronounced influence on the amount of protein that can infiltrate the pSiO₂ matrix (as shown in FIGS. 8 and 9), and it also affects the rate of protein infiltration. FIG. 10 compares the temporal response of BSA infiltration at pI=pH (4.7) and pI>pH (4.2) to theoretical curves derived from Fick's Second law. Fick's Second law describes the time-dependent mass transfer of molecules in a concentration gradient:

$$\frac{\partial c}{\partial t} = D ( \frac{{\partial }^{2} c}{\partial {x}^{2}} + \frac{{\partial }^{2} c}{\partial {y}^{2}} + \frac{{\partial }^{2} c}{\partial {z}^{2}} ) \qquad ( 5 )$$

where D is diffusion coefficient and c is concentration. Considering diffusion into the aligned pores of the pSiO₂ film as a one-dimensional process, the diffusion coefficient can be derived based on the following boundary conditions: (1) at t=0, c=0 anywhere in the pSiO₂ film, and (2) at x=0, c=C₀, where t is time, x is the distance from the pore mouth in the direction is perpendicular to the chip surface, c=concentration and C₀=initial concentration. As previously solved by Crank,⁴¹ the one-dimensional solution to eqn. (5) is given by:

$$c ( x , t ) = {C}_{0} ( 1 - \frac{4}{π} {\sum }_{n = 0}^{∞} \frac{{( - 1 )}^{n}}{2 n + 1} exp [ - {D ( 2 n + 1 )}^{2} {π}^{2} t / 4 {t}^{2} ] cos \frac{( 2 n + 1 ) π x}{2 l} ) \qquad ( 6 )$$

where c(x,t) is the molar concentration and l is the total thickness of the pSiO₂ layer (5.7 mm) and n is an integer corresponding to the number of elements in the discretized solution. In the present case, solutions to eqn. (5) converged for n=10⁴ finite elements. To map this equation to the optical measurement, the total concentration of analyte in the film at time t was determined by summation of the concentration c of analyte in each finite element.

The data for diffusion of BSA into the mesoporous matrix for the case pH=pI (shown in FIGS. 10A and 10B) fits the one-dimensional diffusional model well (R²=0.994), yielding an effective diffusion coefficient of 2.3×10^{31 10} cm²/s. This value is 3 orders of magnitude smaller than the diffusion coefficient for free BSA in solution, which is ˜6×10⁻⁷ cm²/s. The result of the fit indicates that transport of BSA is significantly impeded in the 50-nm pores of the pSiO₂ layer and it is comparable or slightly greater than the literature reports for diffusion of proteins and small molecules in confined porous alumina, agarose gel, and silicon oxides. Flow-through systems were used in the literature experiments, allowing a greater concentration gradient between two compartments and faster diffusion. Although with impeded diffusion rate, the diffusion within the pores appears to follow Fick's 2^{nd} law when the protein exhibits an overall neutral surface charge. Furthermore, the charged surfaces on the protein seem to influence the diffusion behavior, showing a deviation in the fit for concentration based diffusion.

FIGS. 10A and 10B show temporal responses of optical pSiO₂ sensor to the protein BSA, measured at pH=4.7=pI (FIG. 10A) and at pH=4.2<pI is (FIG. 10B). Experimentally determined data points are given as circles, and the lines provide the theoretical prediction of Fick's law for the indicated values of diffusion coefficient. Concentration of protein in solution (C₀)=1.0 mg/mL, introduced at t˜2000 s. The y-axis for the theoretical curves, C/C₀, represents the ratio of concentration of protein in the porous film to the concentration in the bulk solution. The experimental data are presented as change in the quantity nL relative to the final equilibrium value, DnL/nL_{Finalb} where DnL=(nL_{measured}−nLᵢₙᵢₜᵢₐₗ) and nL_{Final}=(nL_{equilibrium}−nLᵢₙᵢₜᵢₐₗ). Ionic strength for buffer solutions=0.01 M.

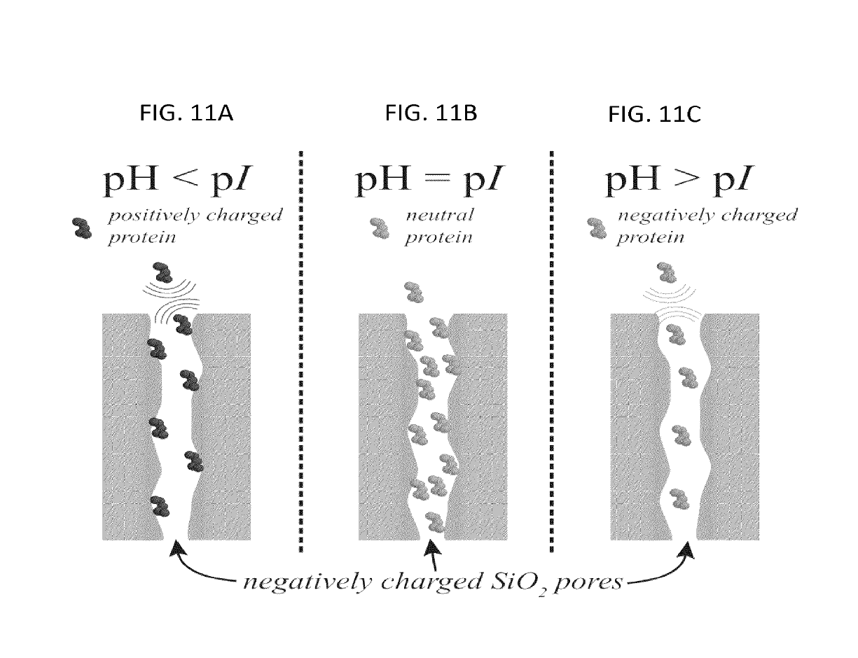

FIGS. 11A-11C model the extent of protein infiltration and the rate at which it is admitted to the mesoporous pSiO₂ film that maximizes at pH=pI (FIG. 11B). When the pH of the solution is equal to pI (FIG. 11B), the protein has no net charge, protein-protein repulsions are minimized, and both the rate and extent of protein infiltration is maximized. Protein transport is concentration-driven. At pH>pI (FIG. 11C), the negatively charged protein is repelled by both the pore walls and other proteins, and diffusion and adsorption are limited. In both the FIG. 11A pH<pI and the FIG. 11C case, electrostatic repulsions are important contributors to the diffusional process. In the model, the 50-nm pores are sufficiently narrow and the ionic strength are sufficiently low that electrostatic protein-protein repulsions in the nano-pores become significant. The three-dimensional electrostatic potential around the protein BSA was also calculated for relevant solution pH and ionic strength values, using the computer program Adaptive Poisson-Boltzmann Solver (APBS) to further understand the mechanism.

For pH values<pI of the protein, the protein carries a net positive charge, and it is expected to be strongly attracted to the negatively charged pore walls (FIG. 11A). This is consistent with prior studies of the loading of IgG antibodies, protein A, and BSA into oxidized porous Si films, where protein loading is maximized for pH values at which the protein carries a net positive charge. For example, in previous work with one of the present inventors, it has been reported that the anti-angiogenic antibody bevacizumab (trade name Avastin) is can be concentrated by >400-fold relative to its solution concentration in a porous SiO₂ film. Sailor, et al, “Sustained Release of a Monoclonal Antibody from Electrochemically Prepared Mesoporous Silicon Oxide,” Adv. Funct. Mater. 2010, 20, 4168-4174. In that study, the ionic strength of the solution used to load the protein was much larger (15×) than the ionic strength used in FIGS. 9A and 9B and FIGS. 10A and 10B, and so protein-protein repulsions were reduced. In the present experiments the protein feels a strong electrostatic attraction to the negatively charged pore surface, but protein-protein repulsions limit the rate and extent of infiltration.

At pH values>pI of the protein, the protein carries a net negative charge, and it is expected to be repelled from the negatively charged pore walls (FIG. 11C). As in the case where the protein carries a net positive charge, protein-protein repulsions are an important limiter of the rate and extent of infiltration. In addition, the pore surface exerts a repulsive force on the negative portion of the protein, which is expected to reduce the total amount of protein adsorbed. The data of FIGS. 8A-8D and FIGS. 9A and 9B support this interpretation; in particular, the smallest quantity of the protein BSA is adsorbed at pH>pI, where the protein carries a net negative charge, rather than at pH<pI, where the protein carries a net positive charge. In both cases the porous SiO₂ surface is negatively charged. In the absence of adsorption, the change in index expected when pure buffer (n=1.333) is replaced with the solution of 1 mg/mL protein (n=1.334) corresponds to <0.1% change in signal. The infiltration data (FIGS. 9A and 9B) indicate that negligible quantities of BSA adsorb at pH>7, while significant adsorption of BHb and EMb occurs even at pH=7.5. The porous SiO₂ matrix used in these studies is unstable (toward hydrolysis) at pH>7.5, precluding the acquisition of data at pH values>7.5.

In all cases studied, protein binding appears to be maximal at pH values where the net charge on the protein is zero (FIGS. 9A and 9B). Although one might expect the strongest binding between the negatively charged porous is SiO₂ surface to be in a pH range where the protein carries a net positive charge (i.e., pH<pI of the protein), the effect of protein-protein repulsions is significant, especially for solutions of low ionic strength (FIGS. 8A-8D). Thus, the optical binding curves show maximal response at pH=pI. The diffusional behavior of the proteins in the pores (FIGS. 10A & 10B) is also closest to the ideal predictions of Fick's law when the protein is neutral.

Ionic strength has a direct effect on the solution's ability to screen the charges on dissolved proteins. The data and experiments support the conclusion that charged proteins are less likely to enter (and they diffuse more slowly in) nanopores when the solution is at a lower ionic strength. Diffusion of neutral proteins (pH=pI) is driven mostly by the concentration gradient in the pSiO₂ layer, and ionic strength exerts little influence in this case (FIG. 8B)

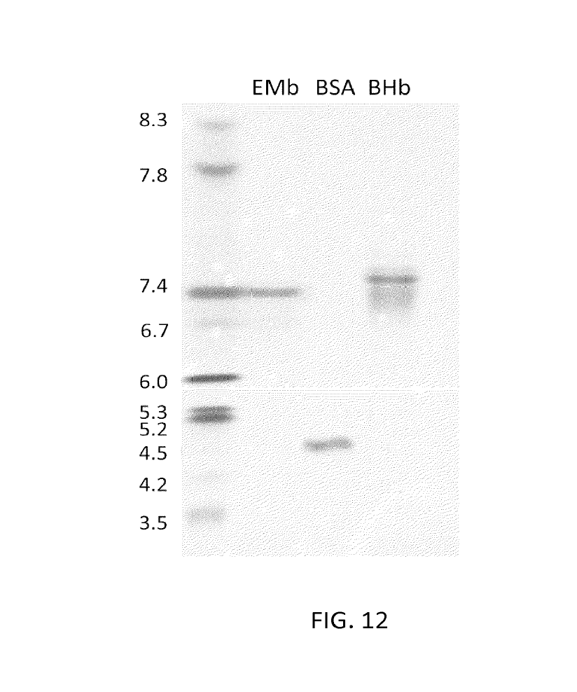

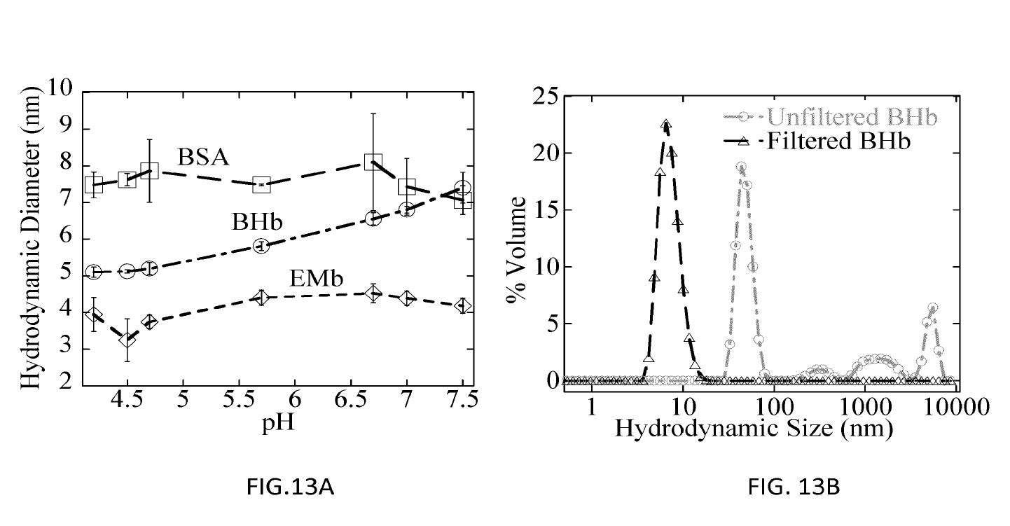

The pores in the pSiO₂ sensor are sufficiently small that they are capable of discriminating between isolated proteins and protein aggregates. IEF (isoelectric focusing) (FIG. 12) and DLS (dynamic light scattering) (FIGS. 13A and 13B) data indicate that the proteins BHb and EMb form aggregates under the conditions of the experiment. FIG. 12 is the IEF gel electrophoresis data with isoelectric pH as indicated on the left. Hydrodynamic diameter of BSA, BHb, and EMb, measured by DLS as a function of pH, obtained on filtered protein solutions. The FIG. 13B DLS traces show particle size distribution for filtered and unfiltered BHb. Unfiltered BHb displays more than one group of hydrodynamic sizes, indicating significant aggregation of the protein under the conditions of the study. A single hydrodynamic size distribution is observed after filtration, yielding a hydrodynamic diameter in agreement with the literature value.

DLS data for EMb (not shown) also indicated more than one set of hydrodynamic sizes. Similar to BHb, a single hydrodynamic size distribution is observed after filtration, yielding a hydrodynamic diameter in agreement with the literature value. BSA exhibits a stable hydrodynamic diameter across the range of pH values studied, with a single peak in the DLS hydrodynamic size histogram is (not shown).

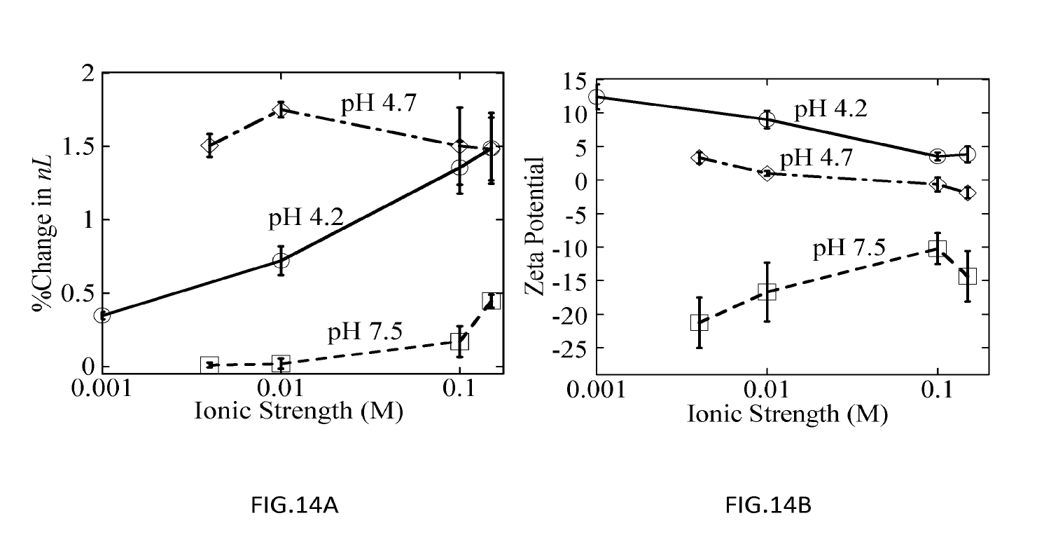

FIGS. 14A and 14B show the influence of solution ionic strength on extent of infiltration and zeta potential of BSA. FIG. 14A shows optical responses (percent change in the quantity nL) of a pSiO₂ sensor to bovine serum albumin (BSA) as a function of ionic strength. A 1.0 mg/mL solution of BSA is measured. FIG. 14B shows zeta potential of BSA as a function of ionic strength, for the pH values indicated.

In sum, a single modal size distribution was obtained upon filtering the protein solutions through a 100-nm cutoff membrane. Filtered and unfiltered protein solutions yielded similar optical responses from the pSiO₂ films, indicating that the nanostructure is rejecting these larger aggregates while still admitting the individual proteins of interest. The ability of porous silicon (including oxidized silicon) has been previously demonstrated as discussed above. In the experiments, the pSiO₂ film yields more distinguishable pI value than the IEF experiment. In addition, the sampling and detection volumes in the present system occupy the same, ultrasmall (5 nL) physical space; thus the approach requires significantly smaller sample volumes and analyte quantities. The optical method of the invention can be complementary to traditional isoelectric focusing as a means of quantifying pI, and it provides real-time, nanostructure-dependent diffusional data that are not accessible by other techniques.

The pH experiments show that admission of a protein into the pores is controlled by the diameter and the surface charge of the pores, and both the rate and the degree of protein infiltration is a function of solution pH. The data show that the rate of protein transport within the pores of the pSiO₂ film is slowed by 3 orders of magnitude relative to the free-solution diffusion values, and it is maximized when the solution pH is equal to the pI of the protein. The experiments indicate that protein diffusion within the nanostructure is influenced by electrostatic interactions between the negatively charged pore walls and the pH-dependent charge on the surface of the protein, providing the ability to determine is protein isoelectric point (pI). The rate and extent of biomolecule infiltration is observed without the use of fluorescent or radioactive labels by harnessing the optical interference property of the film, which provides a real-time measure of the mass of protein in the film. The ultrasmall volume and chip-based format of the system indicated that it is amenable to highly parallel assays. Such features will find particular use and be of particular interest to the bioanalytical chemistry, high throughput screening, proteomics, biotechnology, materials science, and nanoscience communities.

Experimental Details for Charge Based Gating and Detection Materials. Aqueous HF (48%) and ethanol (99.9%) were supplied by EMD and Gold Shield Chemical Company, respectively. Porous silicon samples were prepared from highly doped p-type Si with resistivity ranging from 0.0008-0.001 Ω-cm (polished on the (100) face, boron doped, from Siltronix Corp). Bovine serum albumin (BSA, 66 kDa) was obtained from CalBiochem (Cat. No. 12657). Bovine hemoglobin (BHb, 65 kDa) and equine myoglobin (EMb, 18 kDa), were obtained from Sigma-Aldrich, Cat. No. H2500 and M0630, respectively. All the proteins were used as-received without further purification. 5 mM buffer solutions were prepared by mixing ultrapure (18 MW) water with monobasic sodium phosphate (Cat. No. S369-500 from Fisher), glacial acetic acid (Cat. No. AX0073-75 from EMD Chemicals), or Tris(tris(hydroxymethyl)aminomethane, Cat. No. BP152-500 from Fisher Scientific) depending on the pH and its buffer capacity. Desired pH values were then adjusted by adding a small amount of HCl or NaOH. The ionic strength of the prepared buffer solutions ranged from 0.001 to 0.15 M.

Porous Silicon Preparation and Characterization. Porous silicon samples were anodically etched in a 3:1 solution of aqueous 48% HF: ethanol. Si chips with an exposed area of 1.2 cm² were contacted on the back side with a strip of aluminum foil and mounted in a Teflon etch cell. Samples were then is electrochemically etched in a two-electrode configuration using a platinum mesh counter electrode. Single-layer samples were prepared by application of a current density of 417 mA/cm² for 32 s. Samples were rinsed three times with ethanol and then dried with nitrogen gas. Porosity was characterized using the nondestructive spectroscopic liquid infiltration method (SLIM).

Thermal Oxidation. Porous silicon samples were thermally oxidized in a tube furnace (Lindberg/Blue M) at 750° C. for 1 h in air and then allowed to cool to room temperature.

Interferometric Reflectance Spectra Collection and Data Processing. Reflectance spectra were recorded with an Ocean Optics USB-4000 CCD spectrometer coupled to a bifurcated fiber optic cable. A tungsten halogen light source was used to illuminate the surface of the sample via one arm of the bifurcated fiber. Both the spectral acquisition and light illumination were performed along an axis normal to the surface of the pSiO₂ sample. Effective optical thickness (EOT), defined here as the value 2 nL (where n=average refractive index and L=sample thickness in nm), was obtained from the Fast Fourier Transform (FFT) of the acquired reflectance spectrum. The percent change in nL is defined as (nLₐ−nL_{b})/nL_{b}, where nLₐ is the value obtained in the presence of analyte and nL_{b} is the baseline value obtained in the pure buffer of interest.

Time-Resolved Biosensing Experiments. Buffer solutions ranging in pH from 4.2 to 7.5, with ionic strength 0.01M, were used in the experiments to determine the pI of each test protein. Buffer solutions (pH 4.2, 4.7, and 7.5) with ionic strengths ranging from 0.002 to 0.15M were used in the experiments quantifying the electrostatic interaction between BSA and pSiO₂. A flow cell system fitted with an optically transparent window facilitated acquisition of reflectance spectra. In a typical experiment, spectra were acquired every 30 s and an initial baseline was established in a given buffer solution (flow rate ˜0.5 mL/min) A solution containing 5 mL of the protein of interest (1 mg/mL), is dissolved in the same buffer, was then introduced to the flow cell (flow rate ˜0.5 mL/min) and spectral data were acquired for 1 hr. The buffer solution was circulated in a closed loop during data acquisition (total solution volume=5 mL).

Protein Characterization. Zeta potential and hydrodynamic diameter of each protein was determined by dynamic light scattering (DLS) using a Malvern Zetasizer. Solutions containing 2 mg/mL of each protein were measured. BHb and EMb were measured before and after filtration through a 100-nm syringe filter (Millipore, Cat. No. SLVV033RS). The pI of each protein was determined using IEF (isoelectric focusing) gel electrophoresis (Invitrogen, Cat. No. EC6655A).

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for detecting, concentrating, and separating charged molecules from solution comprising: exposing a solution containing the charged molecules to a material substrate having a electrically conductive and optically responsive conductive porous electrode; applying an electric field across the porous electrode to cause charged molecules to be captured and concentrated by the porous electrode, and separated from other molecules in the solution; and
simultaneously optically detecting charged molecules captured by the porous electrode.

2. The method of claim 1 wherein the material substrate is selected from the group consisting of Si, Ti, Al, Ge, Cds, GaAs, and ZnO.

3. The method of claim 1, wherein the material substrate is comprises carbonized porous silicon.

4. The method of claim 1, wherein the porous electrode is a porous thin film electrode.

5. The method of claim 1, wherein said applying comprises applying a potential to the porous electrode having a magnitude of about 10V or less.

6. The method of claim 1 wherein the charged molecules comprise biomolecules.

7. The method of claim 6, wherein the biomelecules comprises one of more of nucleic acids, proteins, lipids, polysaccharides, and biological metabolites.

8. The method of claim 1, wherein the porous electrode has pores having diameters of less than 100 nm.

9. The method of claim 1 wherein said optically detecting comprises conducting optical interferometery to obtain optical interferometric measurements of the porous nanostructure.

10. The method of claim 1, further comprising adjusting pH of a buffer in the solution to promote capture, concentration and separation of the biomolecules.

11. The method of claim 10, wherein said adjusting comprises setting the pH of the buffer to a value equal to the protein isoelectric point of a is molecule of interest to be captured and concentrated.

12. The method of claim 11, wherein the volume of buffer probed by the optical detector comprises between 50 nL and 0.001 nL.

13. The method of claim 11, wherein said adjusting comprises adding small amount of acid or base to the buffer solution.

14. The method of claim 1, wherein the porous electrode comprises pores sized to accept a molecule of interest and exclude molecules larger than the molecule of interest.

15. The method of claim 1, wherein the porous electrode comprises a multi-layer porous film, having a first layer sized to accept a first molecule of interest and a second layer to accept a second molecule of interest.

16. A method for detecting, concentrating, and separating charged molecules from solution comprising: exposing a solution containing the charged molecules to a material substrate having a porous electrode with pores sized according to a molecule of interest; adjusting the pH of the solution to cause charged molecules to be captured and concentrated by the porous electrode, and separated from other molecules in the solution; and simultaneously optically detecting charged molecules captured by the porous electrode.

17. The method of claim 16, wherein said adjusting comprises setting the pH of the solution to a value equal to the protein isoelectric point of a molecule of interest to be captured and concentrated.

18. The method of claim 17, wherein the volume of solution is probed by the optical detector comprises between 50 nL and 0.001 nL.

19. The method of claim 16, wherein the porous electrode comprises pores sized to accept a molecule of interest and exclude molecules larger than the molecule of interest.
